(19) United States
(12) Patent Application Publication
(10) Pub. No.: US 2007/0275764 A1
(43) Pub. Date: Nov. 29, 2007

(54) Mobile communication terminal and method of controlling

(75) Inventor: Jeong Pil Choi, Incheon (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/727,335

(22) Filed: Mar. 26, 2007

(30) Foreign Application Priority Data
May 25, 2006 (JP) 10-2006-0047135

(51) Int. Cl. H04B 1/38

(52) U.S. Cl. 455/566

(57) ABSTRACT

A mobile communication terminal and a method of controlling the same are disclosed. The mobile communication terminal including a backlight unit comprising a plurality of backlight groups, each backlight group comprising one or more backlight sources, a switch unit configured to selectively turn the backlight groups on or off to enable the backlight groups to alternatingly emit light, and a controller configured to control the switch unit according to backlight driving information.

### CROSS-REFERENCE TO RELATED APPLICATION

This non-provisional application claims priority under 35 U.S.C § 119(a) on Patent Application No. 10-2006-0047135 filed in Korea on May 25, 2006, the entire contents of which are hereby incorporated by reference.

### BACKGROUND OF THE INVENTION

1. Field of the Invention

The present invention relates to a mobile communication terminal and a method of controlling the same.

2. Description of the Related Art

Usually, a mobile communication terminal comprises an illumination unit that can be used to display an image or can be used under low illumination at night.

A Liquid Crystal Display (hereafter, referred to as “LCD”), which is used as a display device of the mobile communication terminal, is generally not a self-emissive device. Thus, the LCD includes a backlight unit on the rear side of the LCD panel so that the image may be displayed by passing a light produced by the backlight unit through a liquid crystal layer and a color filter.

A keypad of the mobile terminal includes a light source such as an LED on the rear side of a key top, in which a printing surface of numerals or characters is formed, so that the light produced by the LED is illuminated to the outside of the key top. As a result, a user can recognize the numerals or characters that are printed on a key by a backlighting effect of the LED.

As discussed above, the display device and keypad of the mobile communication terminal are provided with the backlight illumination units for providing light. However, a larger capacity battery is required to drive such backlight illumination units, which has large power consumption and increases the size of the mobile communication terminal.

Therefore, there is a need for an apparatus and method that can minimize power consumption necessary for driving the backlight illumination units in the mobile communication terminal.

### SUMMARY OF THE INVENTION

Accordingly, the present invention has been made to address the above-mentioned and other problems associated with the related art.

An object of the present invention is to provide a mobile communication terminal having a backlight unit and a method of controlling the same that can reduce power consumption necessary for driving the backlight unit.

Additional advantages, objects and features of the invention will be set forth in part in the description which follows and in part will become apparent to those having ordinary skill in the art upon examination of the following or may be learned from practice of the invention.

In one aspect of the present invention, there is provided a mobile communication terminal, which comprises a backlight unit comprising a plurality of backlight groups, each backlight group comprising one or more backlight lamps; a switch configured to switch the backlight lamps on or off to enable each of backlight groups to alternately emit light; and a controller configured to control the switch according to predetermined backlight driving information.

In another aspect of the present invention, there is provided a method of controlling a mobile communication terminal, which comprises dividing a plurality of backlight lamps in a backlight unit into a plurality of backlight groups; and emitting light alternately each of the backlight groups by switching the backlight lamps on or off according to predetermined backlight driving information.

According to another aspect of the present invention, there is provided a mobile communication terminal comprising a backlight unit comprising a plurality of backlight groups, each backlight group comprising one or more backlight sources, a switch unit configured to selectively turn the backlight groups on or off to enable the backlight groups to alternatingly emit light, and a controller configured to control the switch unit according to backlight driving information.

According to another aspect of the present invention, there is provided a method of controlling a mobile communication terminal, the method comprising dividing a backlight unit into a plurality of backlight groups, each backlight group including one or more backlight sources, and selectively turning the backlight groups on or off according to backlight driving information so as to enable the backlight groups to alternatingly emit light.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram for controlling a mobile communication terminal having a backlight unit according to the present invention;

FIG. 2 is a block diagram illustrating a method of controlling a backlight unit of a display device in a mobile communication terminal according to an embodiment of the present invention;

FIG. 3 is a block diagram illustrating a method of controlling a backlight unit of a keypad in a mobile communication terminal according to an example of the present invention;

FIG. 4 is a block diagram illustrating a method of controlling a backlight unit of a keypad in a mobile communication terminal according to another example of the present invention; and

FIG. 5 is a block diagram illustrating a method of controlling a backlight unit of a keypad in a mobile communication terminal according to another example of the present invention.

### DETAILED DESCRIPTION OF THE PREFERRED EMBODIMENTS

Hereinafter, the preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

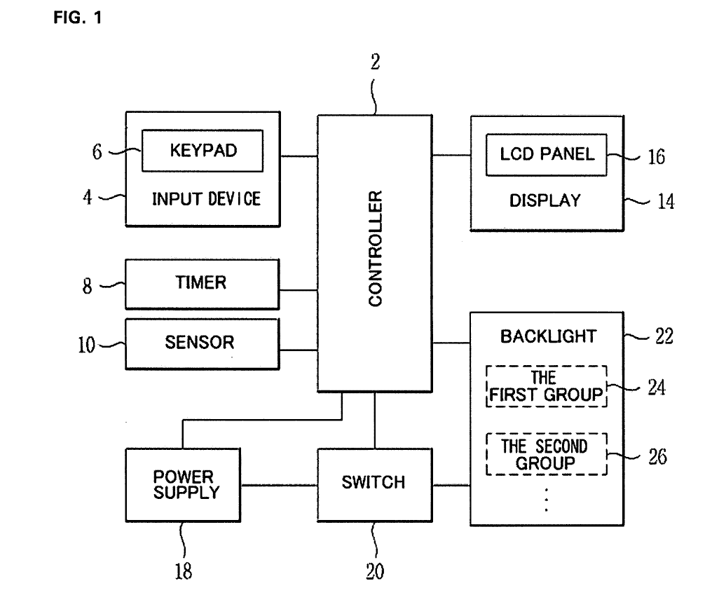

FIG. 1 is a block diagram for controlling a mobile communication terminal having a backlight unit according to an embodiment of the present invention.

Referring to FIG. 1, the mobile communication terminal comprises an input device 4 for inputting data through a keypad 6, a display device 14 for displaying images on an LCD panel 16, a power supply 18, a backlight unit 22 for providing an illumination light to the keypad 6 and the LCD panel 16, a switch (or switch unit) 20 interposed between the power supply 18 and the backlight unit 22 for regulating power that is applied to the backlight unit 22, and a controller 2 for controlling the switch 20 so as to enable the backlight unit 22 to be switched on or off according to predetermined driving information. In addition, the mobile communication terminal comprises a timer 8 for counting a time to enter a power save mode, and a sensor 10 for sensing outer illumination. The controller also controls the switch 20 so as to enable the backlight unit 22 to be switched on or off according to output values from the timer 8 and the sensor 10. All the components of the mobile communication terminal are operatively coupled and configured.

The input device 4 comprises the keypad 6 for inputting numerals and characters, special shapes, navigation key(s), icons, symbols, signs, menu key(s), side key(s), and others, so as to output a corresponding input signal according to a user's selection/input. The backlight unit 22 is installed on the rear side of a key top of the keypad 6 so as to enable the light from the backlight unit 22 to pass through the key top and illuminate the key top. Thus, a user can recognize the numerals, characters and special shapes, etc. provided on the outer surface of the key top.

The display device 14 displays data and images on the LCD panel 16 by receiving the illumination light from the backlight unit 22 that is installed on the rear side of the LCD panel 16.

The backlight unit 22 comprises a plurality of backlight lamps for providing the illumination light. Each of the backlight lamps receives a driving power supply from the power supply 18 to provide the illumination light to the keypad 6 and LCD panel 16. Light emitting devices such as light emitting diodes (LEDs), organic light emitting diodes (OLEDs), and others, may be applied as the backlight lamps. The backlight unit 22 may be provided with one or more backlight lamps to assure sufficient illumination. The plurality of backlight lamps are divided into a plurality of backlight groups such as a first group 24, a second group 26, . . . (as needed), each group of which has at least one or more backlight lamps. Each of the groups 24 and 26 is selectively switched on or off. In this example, two backlight groups are discussed, but any number of backlight groups can be provided in the backlight unit 22.

The switch 20 is interposed between the power supply 18 and the backlight unit 22 to selectively switch the backlight lamps on or off according to each of the backlight groups 24 and 26.

The controller 2 outputs a switching control signal to the switch 20 so as to sequentially switch each of the backlight groups 24 and 26 on or off according to predetermined backlight driving information. The backlight driving information can be supplied from the controller 2 or the backlight unit 22, and may comprise a period of switching each of the backlight groups 24 and 26 on or off and a sequence of emitting light for each of the backlight groups 24 and 26. Such backlight driving information may be stored as basic value in a system's design, and be set directly by the user by providing a desired menu for the user's setting.

The controller 2 shortly sets the period of switching the backlight groups 24 and 26 selectively on or off within the range such that the user can not visually recognize the fact that they are being switched on or off. As a result thereof, when the user sees with the naked eye, the illumination of the backlight unit 22 may be constantly recognized. Accordingly, each of the backlight groups 24 and 26 of the backlight unit 22 alternatingly emit light. In other words, the first backlight group 24 is switched on while the second backlight group 26 is switched off, or the first backlight group 24 is switched off while the second backlight group 26 is switched on. Accordingly, the power consumption necessary for driving the backlight unit 22 can be reduced.

Meanwhile, if the power save mode function is applied, the controller 2 checks through the timer 8 about whether there is no input from the input device 4 during a predetermined time or more. If so, the power save mode is entered. In this case, the controller 2 controls the increase in the period of switching the backlight groups 24 and 26 on or off or the reduction in the number of the switched-off backlight groups, thereby reducing the power consumption necessary for driving the backlight unit 22.

Further, the controller 2 controls the period of switching each of the backlight groups 24 and 26 on or off according to a periphery illumination sensed by the sensor 10, thereby allowing the illumination of the keypad 6 or the LCD panel 16 to be automatically controlled.

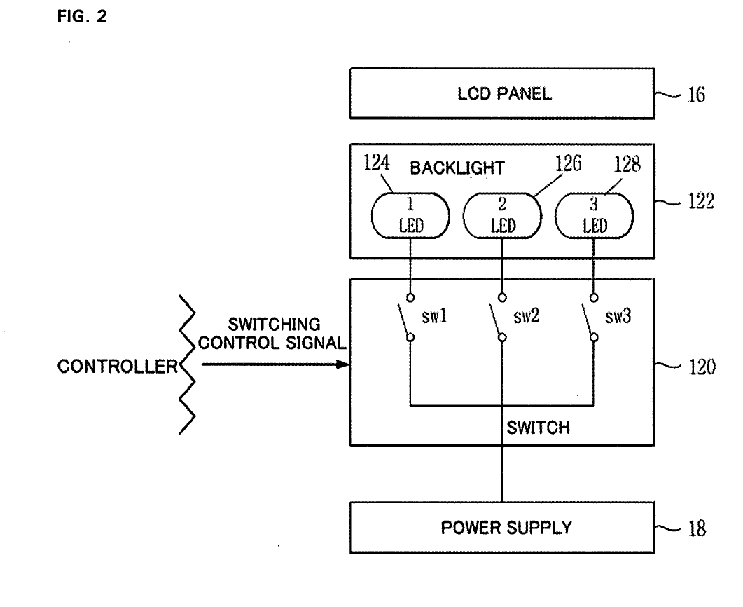

FIG. 2 is a block diagram illustrating a process of controlling a backlight unit of a display device in a mobile communication terminal according to an exemplary embodiment of the present invention. The components 120 and 122 respectively represent specific examples of the components 20 and 22 in FIG. 1. In this example, the backlight unit 122 comprises three LEDs as a backlight lamp for illuminating the LCD panel 16, and the three LEDs are divided into three groups for control. In other words, the LEDs 1, 2 and 3 are respectively classified into the first, the second and the third groups 124, 126, and 128. Although one LED is shown to be in each of the groups 124, 126, and 128, multiple LEDs may be provided in each group.

The backlight unit 122 for illuminating the LED panel 16 is constituted of the first, second and third groups 124, 126, and 128 corresponding to the respective LED1, LED2, and LED3. The switch unit 120 comprises switches SW1, SW2, and SW3 corresponding to each of the backlight groups 124, 126 and 128, so as to respectively switch each of the backlight groups 124, 126 and 128 on or off. Thus, the controller 2 outputs a control signal for switching the switches SW1, SW2 and SW3 on or off according to the backlight driving information.

The controller 2 can sequentially switch each of the backlight groups 124, 126 and 128 on or off so as to enable only a part of the backlight groups 124, 126, and 128 to be switched on. Thus, the controller 2 can control so as to enable one or two of the backlight groups 124, 126 and 128 to be switched off.

Table 1 shows examples of different states of switching the backlight groups on or off when the backlight unit 122 is driven.

TABLE 1

| Control state | | LED 1 | LED 2 | LED 3 |
|---|---|---|---|---|
| First | F1 | ON | ON | OFF |
| mode | F2 | ON | OFF | ON |
| | F3 | OFF | ON | ON |
| Second | S1 | ON | OFF | OFF |
| mode | S2 | OFF | ON | OFF |
| | S3 | OFF | OFF | ON |

As shown in Table 1, in the case of the first mode (F1, F2 and F3), one of the backlight groups 124, 126, and 128 is driven at the OFF state, and in the case of the second mode (S1, S2 and S3), two of the backlight groups 124, 126, and 128 are driven at the OFF state. For instance, the first mode is composed of 3 different stages (F1, F2 and F3) that are sequentially repeated, wherein at any given stage F1, F2 or F3, only one backlight group is turned off while the other two backlight groups are turned on. The second mode can operate in the similar manner. If the number of backlight groups in the OFF state is increased, the power consumption is reduced, but the illumination is lowered.

Therefore, the control state of the backlight unit 122 is properly controlled considering the illumination and power state. The control state of the backlight unit 122 can be directly selected by the user.

The controller 2 judges through the timer 8 about whether to enter the power save mode. As a result of this judgment, in the case where the backlight unit 122 is entered into the power save mode, the control state of the backlight unit 122 may be changed from the first mode to the second mode. In addition, the control state of the backlight unit 122 may be changed to the first mode having high illumination of the LCD panel 16 or the second mode having low illumination according to periphery illumination sensed by the sensor 10.

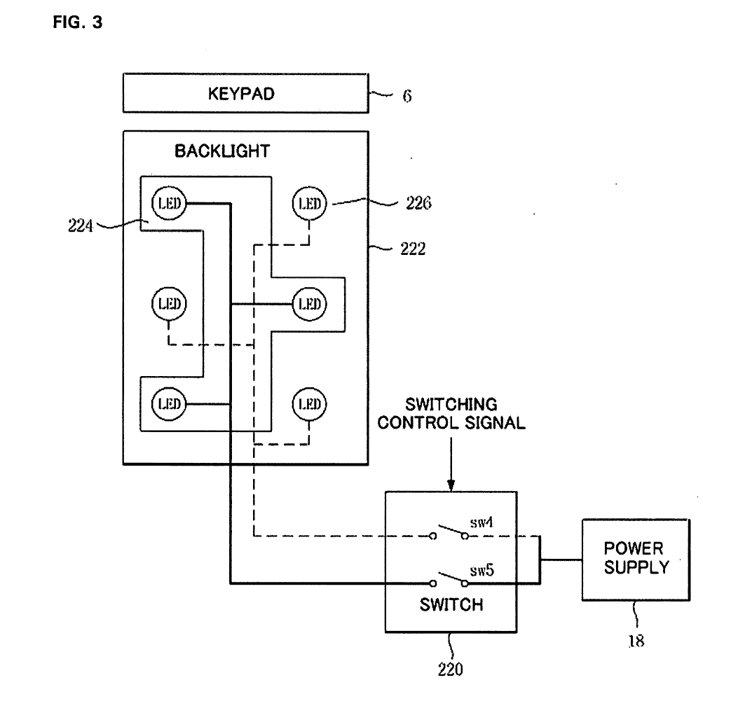

FIG. 3 is a block diagram for illustrating a process of controlling a backlight unit of a keypad in a mobile communication terminal according to another example of the present invention. The components 220 and 222 respectively represent specific examples of the components 20 and 22 in FIG. 1. In this example, the backlight unit 222 comprises six LEDs as a backlight lamp for illuminating the keypad 6, and the six LEDs are divided into two groups 224 and 226 for control.

In other words, in the case where the six LEDs are arranged into two columns, each column having three LEDs, the six LEDs are classified into two groups 224 and 226 by alternately grouping them. The switch 220 comprises switches SW5 and SW4 corresponding respectively to the first and second groups 224 and 226, so as to selectively switch each group of the backlight unit 222 on or off.

The controller 2 outputs a switching signal for controlling on/off operations of each of the switches SW4 and SW5 according to the backlight driving information, so as to enable the LEDs of the first and second groups 224 and 226 to be alternatingly switched on or off. Accordingly, the keypad 6 is illuminated through any one of the first and second groups 224 and 226 whenever the LEDs are switched on or off.

Table 2 shows an example of two states in which the backlight groups 224 and 226 are turned on or off when the backlight unit 222 is driven.

TABLE 2

| First group | Second group |
|---|---|
| ON | OFF |
| OFF | ON |

As shown in Table 2, each of the backlight groups 224 and 226 alternatingly emit light. For instance, the LEDs in the first group 224 are turned on while the LEDs in the second group 226 are turned off. Then the vice versa occurs. This is repeated. Thus, a half (or substantially half) of all backlight lamps are switched on, while the other half are switched off at a given moment, thereby reducing power consumption in association with driving the backlight unit.

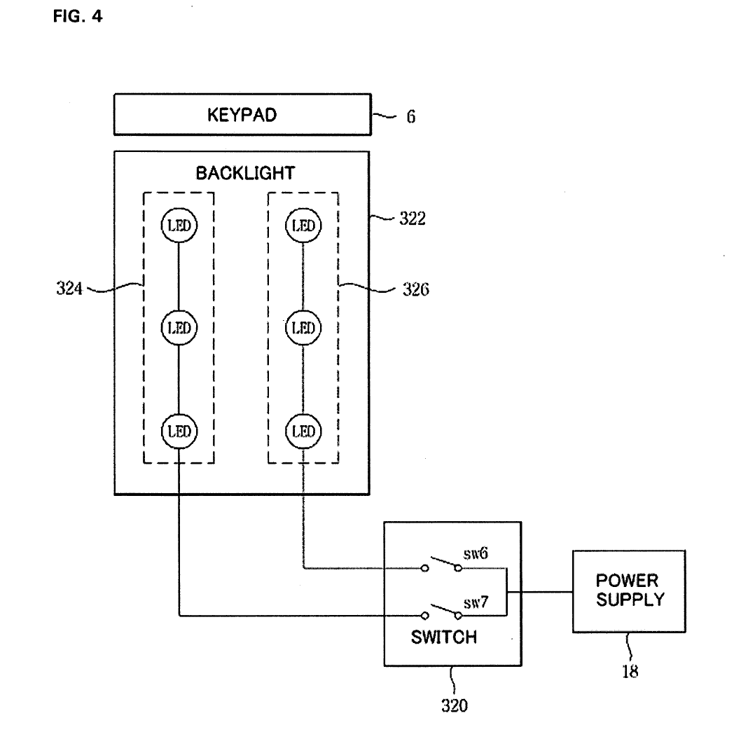

FIG. 4 is a block diagram for illustrating a process of controlling a backlight unit of a keypad in a mobile communication terminal according to another example of the present invention. The components 320 and 322 respectively represent specific examples of the components 20 and 22 in FIG. 1. In this example, the backlight unit 322 comprises six LEDs as a backlight lamp for illuminating the keypad 6, and the six LEDs are divided into two groups 324 and 326 for control.

In the case where the six LEDs are arranged into two columns, each column having three LEDs, the six LEDs are divided into the two groups 324 and 326 by grouping them in a column unit. The switch unit 320 comprises switches SW7 and SW6 corresponding respectively to the first and the second groups 324 and 326, so as to selectively switch the backlight lamps in the column unit on or off.

The controller 2 outputs a switching signal for controlling on/off operations of each of the switches SW6 and SW7 in the switch 320 according to the backlight driving information, so as to enable LEDs of the first and second groups 324 and 326 to alternatingly be switched on or off. The switching sequence as shown in Table 2 can be applied to the first and second groups 324 and 326 Accordingly, the keypad 6 is illuminated through any one of the first and second groups 324 and 326, whenever the LEDs are switched on or off. The on/off operations of each of the respective groups 324 and 326 may be controlled as shown in Table 2.

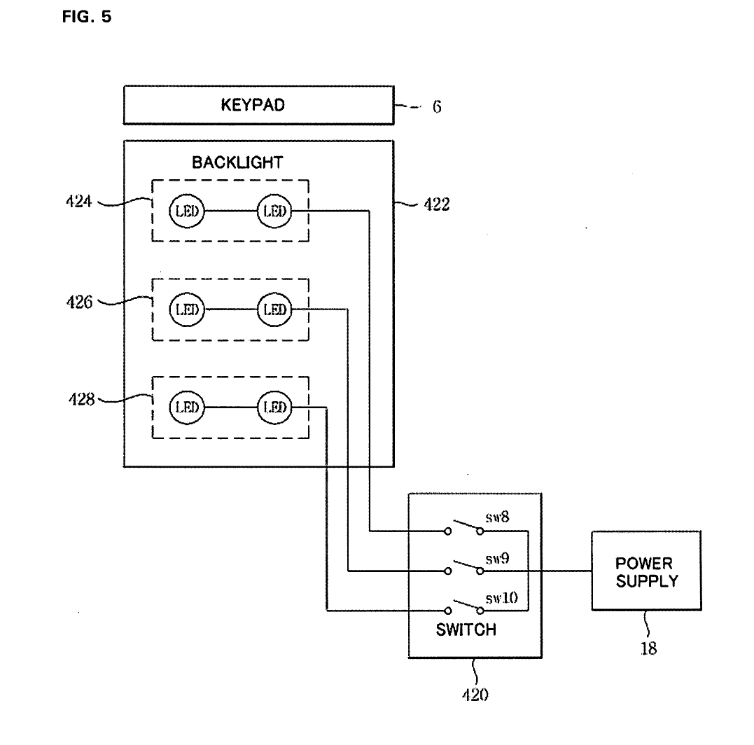

FIG. 5 is a block diagram for illustrating a process of controlling a backlight unit of a keypad in a mobile communication terminal according to another example of the present invention. The components 420 and 422 respectively represent specific examples of the components 20 and 22 in FIG. 1. In this example, the backlight unit 422 comprises six LEDs as a backlight lamp for illuminating the keypad 6, and the six LEDs are divided into three groups 424, 426, and 428 for control.

In the case where the six LEDs are arranged into three rows, each row having two LEDs, they may be divided into three groups 424, 426, and 428, by grouping them in a row unit. The switch unit 420 comprises switches SW8, SW9 and SW10 corresponding respectively to the first, second, and third groups 424, 426, and 428, so as to selectively switch the backlight lamps of each group 424, 426, and 428 on or off.

The controller 2 may control so as to enable one or two of three backlight groups 424, 426 and 428 to be switched off, by sequentially switching the backlight group 424, 426 and 428 on or off.

Table 3 shows an example of different states of switching the backlight groups 424, 426 and 428 on or off when the backlight unit 422 is driven.

TABLE 3

| Control state | First group | Second group | Third group |
|---|---|---|---|
| First mode | ON | ON | OFF |
| | ON | OFF | ON |
| | OFF | ON | ON |
| Second mode | ON | OFF | OFF |
| | OFF | ON | OFF |
| | OFF | OFF | ON |

As shown in Table 3, in the case of the first mode, any one of the backlight groups 424, 426, and 428 is always driven at the OFF state. In the case of the second mode, any two of the backlight groups 424, 426, and 428 are always driven at the OFF state. If the number of backlight groups of the OFF state is increased, the power consumption is reduced, but the illumination is lowered.

Therefore, the control state of the backlight unit 422 is properly controlled considering the illumination and power state. The user can directly select the number of switching-on backlight groups 424, 426 and 428, and a period of switching the backlight groups 424, 426 and 428 on or off.

The controller 2 judges through the timer 8 about whether to enter the power save mode. As a result of this judgment, in the case where the backlight unit 422 is entered into the power save mode, the control state of the backlight unit 422 may be changed from the first mode to the second mode. In addition, the control state of the backlight unit 422 may be automatically changed to the first mode having high illumination of the LCD panel 16 or the second mode having low illumination, according to periphery illumination sensed by the sensor 10.

Although specific examples of the LED numbers and backlight groupings are discussed above, the present invention is not limited thereto and other examples are covered by the present invention. For instance, in FIG. 3, there can be more than two backlight groups and each backlight group can have more than three LEDs. In FIG. 4, there can be more than two backlight groups, and each backlight group can have two or more than three LEDs. In FIG. 5, there can be two or more than three backlight groups, and each backlight group can have more than three LEDs. Also, instead of LEDs, other types of light sources (e.g., OLEDs, etc.) may be used.

As describe above, the mobile communication terminal having the backlight unit and the method of controlling the same, according to the embodiments of the present invention, divide the plurality of backlight sources/lamps for providing the illumination light into the plurality of backlight groups, so that each backlight group can sequentially and/or alternatingly emit light. Therefore, power consumption for driving the backlight unit can be reduced.

The embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A mobile communication terminal, comprising:
a backlight unit comprising a plurality of backlight groups, each backlight group comprising one or more backlight sources;
a switch unit configured to selectively turn the backlight groups on or off to enable the backlight groups to alternatingly emit light; and
a controller configured to control the switch unit according to backlight driving information.

2. The mobile communication terminal of claim 1, wherein the backlight driving information comprises the number of the backlight sources in each of the backlight groups.

3. The mobile communication terminal of claim 1, wherein the backlight driving information comprises a period of switching the backlight groups on or off.

4. The mobile communication terminal of claim 1, wherein the controller varies a period of switching the backlight groups on or off according to the backlight driving information.

5. The mobile communication terminal of claim 1, further comprising:
an input device configured to set the backlight driving information.

6. The mobile communication terminal of claim 1, further comprising:
a timer, wherein the controller checks the timer and reduces the number of switched-on backlight groups, when there is no input from an external source during a predetermined time as a result of the checking through the timer.

7. The mobile communication terminal of claim 1, further comprising:
a timer, wherein the controller checks the timer and increases a period of switching the backlight groups on or off, when there is no input from an external source during a predetermined time as a result of the checking through the timer.

8. The mobile communication terminal of claim 1, further comprising:
a sensor configured to sense outer illumination, wherein the controller controls a period of switching the backlight groups on or off according to the outer illumination sensed by the sensor.

9. The mobile communication terminal of claim 1, further comprising:
a display device, wherein the backlight unit supplies the light to the display device so that the backlight unit functions as a backlight source for the display device.

10. The mobile communication terminal of claim 1, further comprising:
an input device having an indicator printed thereon, wherein the backlight unit is installed below the printed indicator and supplies the light to the input device so that the light passes through the input device to illuminate the printed indicator.

11. The mobile communication terminal of claim 10, wherein the indicator includes one or more of characters, numerals, icons, signs, and/or symbols.

12. The mobile communication terminal of claim 1, wherein when the backlight unit is driven, only one of the backlight groups is turned on at any time.

13. The mobile communication terminal of claim 1, wherein when the backlight unit is driven, only two of the backlight groups are turned on at any time.

14. The mobile communication terminal of claim 1, wherein each of the backlight groups includes a plurality of light sources arranged in a column, in a row, or in a zig-zag configuration.

15. A method of controlling a mobile communication terminal, the method comprising:
dividing a backlight unit into a plurality of backlight groups, each backlight group including one or more backlight sources; and
selectively turning the backlight groups on or off according to backlight driving information so as to enable the backlight groups to alternatingly emit light.

16. The method of claim 15, wherein the backlight driving information comprises the number of the backlight sources in each of the backlight groups, and/or a period of switching the backlight groups on or off.

17. The method of claim 15, wherein the selectively turning step comprises varying a period of switching each of the backlight groups on or off according to the backlight driving information.

18. The method of claim 15, further comprising:
storing the backlight driving information according to a user's selection.

19. The method of claim 15, further comprising:
if there is no input from an external source during a predetermined time, entering a power save mode; and
controlling a period of switching the backlight groups on or off to thereby reduce the number of the switched-on backlight groups.

20. The method of claim 15, further comprising:
sensing outer illumination;
checking whether the sensed illumination is above reference illumination; and
if so, reducing the number of the backlight groups by controlling a period of switching the backlight groups on or off.

21. The method of claim 15, wherein during the selectively turning step, only one of the backlight groups is turned on at any time.

22. The method of claim 15, wherein during the selectively turning step, only two of the backlight groups are turned on at any time.

23. The method of claim 15, wherein in the dividing step, each of the backlight groups includes a plurality of light sources arranged in a column, in a row, or in a zig-zag configuration.
